(19) United States
(12) Patent Application Publication
(10) Pub. No.: US 2011/0160346 A1
(43) Pub. Date: Jun. 30, 2011

(54) DISPERSION OF CARBON NANOTUBES BY MICROFLUIDIC PROCESS

(75) Inventors: Zvi Yaniv, Austin, TX (US); Dongsheng Mao, Austin, TX (US)

(73) Assignee: Applied Nanotech Holdings, Inc., Austin, TX (US)

(21) Appl. No.: 13/040,085

(22) Filed: Mar. 3, 2011

Related U.S. Application Data
(63) Continuation-in-part of application No. 11/757,272, filed on Jun. 1, 2007.
Application No. 11/757,272 is a continuation-in-part of application No. 11/693,454, filed on Mar. 29, 2007.
Application No. 11/757,272 is a continuation-in-part of application No. 11/695,877, filed on Apr. 3, 2007, now abandoned.
(60) Provisional application No. 60/819,319, filed on Jul. 7, 2006.
(60) Provisional application No. 60/810,394, filed on Jun. 2, 2006.
(60) Provisional application No. 60/788,234, filed on Mar. 31, 2006.
(60) Provisional application No. 60/810,394, filed on Jun. 2, 2006.
(60) Provisional application No. 60/789,300, filed on Apr. 5, 2006.
(60) Provisional application No. 60/810,394, filed on Jun. 2, 2006.

(51) Int. Cl. C09D 163/00; C08G 59/14; C08G 59/16; C08K 3/04

(52) U.S. Cl. 523/468; 525/523; 525/533; 523/400

(57) ABSTRACT

Improved mechanical properties of carbon nanotube (CNT)-reinforced polymer matrix nanocomposites are obtained by functionalizing the CNTs with a compound that bonds well to an epoxy matrix before dispersing the solution using a microfluidic process. Well-dispersed particles are obtained that sufficiently improve mechanical properties of the nanocomposites, such as flexural strength and modulus. The resulting composite material is used for coatings on marine vessels.

### CROSS-REFERENCE TO RELATED APPLICATIONS

This application for patent is a continuation-in-part application of U.S. patent application Ser. No. 11/757,272, which claims priority to U.S. Provisional Patent Application Ser. Nos. 60/819,319 and 60/810,394, and which is a continuation-in-part of U.S. patent application Ser. No. 11/693,454, which claims priority to U.S. Provisional Application Ser. Nos. 60/788,234 and 60/810,394, and which is a continuation-in-part of U.S. patent application Ser. No. 11/695,877, which claims priority to U.S. Provisional Application Ser. Nos. 60/789,300 and 60/810,394, all of which are hereby incorporated by reference herein.

### TECHNICAL FIELD

The present invention relates in general to composite materials, and in particular, to composite materials that include carbon nanotubes.

### BACKGROUND INFORMATION

All boats whether they are constructed from ferro-cement, steel, glass fiber, or wood, require good protection from the harsh environment in which they reside, e.g., salt water. A coating system is a selection of adhesives and the order in which they are applied to the boat hull to offer this protection. Typically, this consists of a sealing coat to seal and prime the natural hull surface, followed by several barrier coats to keep the water out, and topped off with an antifouling coating designed to keep the hull free of weeds and barnacles. Most hull types have problems with their coating systems of one sort or other; ferro-cement hulls are no exception. Epoxy coatings are extremely tough, durable, and highly resistant to chemicals, abrasion, moisture, and alcohol. Epoxy coatings are widely used as antifouling coating for marine vessels, such as boats, ships, yachts, etc. They can be applied to different marine surfaces such as wood, metal (e.g., aluminum) or alloy, or glass fiber composite, with good adhesion.

However, current adhesive systems, including epoxy adhesions for coating of marine vessels, have serious short and long term problems for protection purposes. Sooner or later, the adhesion of the antifouling paint with the marine hull is weakened, as well as a performance downturn from a rough, uneven surface. For example, the marine hull will expand or shrink at different temperatures in water, which will cause it to crack or blister. As long as a crack initiates, it can easily propagate and grow, eventually damaging the coatings. New antifouling coatings need to be applied after the damaged coating is removed and cleaned. Not only is it expensive to remove and clean the antifouling coating, but the process is very complicated, expensive, and time consuming. Furthermore, the antifouling coating is not strong enough to prevent damage when it is removed using a cleaning process, such as brushing.

Nanocomposites are composite materials that contain particles in the size range of 1-100 nm. These materials bring into play the submicron structural properties of molecules. These particles such as clay and carbon nanotubes (CNTs) generally have excellent properties, a high aspect ratio and a layered structure that maximizes bonding between the polymer and particles.

Adding a small quantity of these additives (0.5-5%) can increase many of the properties of polymer materials, including higher strength, greater rigidity, high heat resistance, higher ultraviolet (UV) resistance, lower water absorption rate, lower gas permeation rate, and other improved properties (see, T. D. Forties, D. L. Hunter, and D. R. Paul, “Nylon-6 nanocomposites from Alkylammonium-modified clay: The role of Alkyl tails on exfoliation,” Macromolecules 37, 1793-1798 (2004)).

However, dispersion of the nanoparticles is very important to reinforce polymer matrix nanocomposites. Up to now, dispersion of those nanoparticles in a polymer matrix has been a problem. Conventional dispersion methods such as ball milling, ultrasonication, and monogenization are not effective ways to disperse the particles. For example, a ball milling process takes a very long time to disperse the particles. Moreover, the particles are broken rather than dispersed. The energy of the ultrasonication process is not enough to disperse carbon nanotube ropes or layered clay particles. That is why those nanoparticle-reinforced nanocomposites do not achieve excellent properties as expected (see, Shamal K. Mhetre, Yong K. Kim, Steven B. Warner, Prabir Phaneshwar Katangur, and Autumn Dhanote, “Nanocomposites with functionalized carbon nanotubes,” Mat. Res. Soc. Symp. Proc. Vol. 788, L11.17.1-6 (2004); Chun-ki Lam, Kin-tak Lau, Hoi-yan Cheung, Hang-yin Ling, “Effect of ultrasound sonication in nanoclay clusters of nanoclay/epoxy composites,” Materials Letters 59, 1369-13722005)).

However, dispersion of the nanoparticles is very important to reinforce polymer matrix nanocomposites. Up to now, dispersion of those nanoparticles has been a problem in the polymer matrix. Conventional dispersion methods such as ball milling, ultrasonication, and monogenization are not effective ways to disperse the particles. For example, ball milling processes have been using for a century, but it takes a very long time to disperse the particles. Moreover, the particles are rather more broken than dispersed. The energy of the ultrasonication process is not enough to disperse the carbon nanotube ropes or layered clay particles. That is why those nanoparticle-reinforced nanocomposites do not achieve excellent properties as expected (see, Shamal K. Mhetre, Yong K. Kim, Steven B. Warner, Prabir Phaneshwar Katangur, and Autumn Dhanote, “Nanocomposites with functionalized carbon nanotubes,” Mat. Res. Soc. Symp. Proc. Vol. 788, L11.17.1-6 (2004); Chun-ki Lam, Kin-tak Lau, Hoi-yan Cheung, Hang-yin Ling, “Effect of ultrasound sonication in nanoclay clusters of nanoclay/epoxy composites,” Materials Letters 59, 1369-1372 (2005)). Researches also studied the ways to reduce the crack propagation and growth of the polymer matrix using CNT reinforcement. It showed that the crack growth rate can be significantly reduced by (1) reducing the nanotube diameter, (2) increasing the nanotube length, and (3) improving the nanotube dispersion (see, W. Zhang, R. C. Picu, and N. Koratkar, “The effect of carbon nanotube dimensions and dispersion on the fatigue behavior of epoxy nanocomposites,” Nanotechnology 19, 285709 (2008).

Using CNTs as a reinforcing component in polymer composites also requires the ability to tailor the nature of the CNT walls in order to control the interfacial interactions between the CNTs and the polymer chains to improve the mechanical properties (see, A. Romov, S. Dittmer, J. Svensson, O. A. Nerushev, S. A. Perez-Garcia, L. Licea-Jimenez, R. Rychwalshi, and E. E. B. Campbell, Journal of Materials Chemistry 15, 3334 (2005)). These interactions govern the load-transfer efficiency from the polymer to the CNTs and hence the reinforcement efficiency. Studies showed that strong interfacial bonding is critical to improve stiffness and strength of the CNT-reinforced composites (see, Erik T. Thostenson, Zhifeng Ren, Tsu-Wei Chou, “Advances in the science and technology of carbon nanotubes and their composites: a review,” Composites Science and Technology 61, 1899-1912 (2000)).

### BRIEF DESCRIPTION OF THE DRAWINGS

FIG. 1 illustrates an SEM image of NH₂-functionalized DWNTs;

FIG. 2 illustrates NH₂-DWNT/acetone solution dispersed by a microfluidic process (left) and ultrasonication (right);

FIG. 3 illustrates a process flow to manufacture epoxy/CNT nanocomposites; and

FIG. 4 illustrates a flexural surface of a MWNT-reinforced epoxy nanocomposite: (left) COOH-MWNT (1.5 wt. %) and (right) non-functionalized MWNT (1.5 wt. %).

### DETAILED DESCRIPTION

Therefore, it is very important to improve the mechanical properties of the epoxy adhesive as an antifouling coating to improve the crack propagation resistance, so that it will not be easily damaged, the lifetime of the coating will be extended, and the maintenance cost will be lowered. Embodiments of the present invention improve mechanical properties of CNT-reinforced polymer matrix nanocomposites by utilizing the following steps, significantly improving the crack propagation resistance:
1. Functionalize the CNTs on their surface so that they can form strong bonding with the epoxy matrix;
2. Disperse the functionalized CNTs in an epoxy resin using a microfluidic dispersion process to form excellent dispersion of the functionalized CNTs in the epoxy matrix.

The following examples are described.

### Epoxy, Hardener, Double-Wall CNTs (DWNTs), and Multi-Wall CNTs (MWNTS)

DWNTs were obtained from Nanocyl, Inc., Namur, Belgium (Nanocyl-2100 product series). The DWNTs had an average outer diameter of 3.5 nm and lengths of 1-10 μm. The DWNTs were produced via a catalytic carbon vapor deposition (CCVD) process, though other processes could be utilized. CNTs collected from the reactor were then purified to greater than 90% carbon by the manufacturer. MWNTs were obtained from Mitsui Co., Japan and other vendors. The MWNTs were highly purified (>95% purity). Epon 828 epoxy resin and hardener (dicyandiamide) used to cure the epoxy were obtained from Mitsubishi Corporation, Japan.

### Functionalization of DWNTs and MWNTs

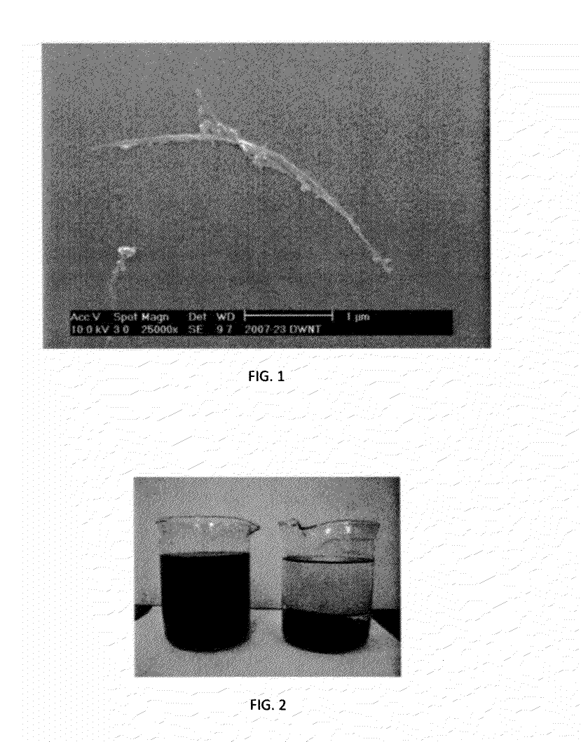

The purified DWNTs and MWNTs were first put through an oxidation process by placing them in a 3:1 HNO₃/H₂SO₄ solution. The DWNTs and MWNTs in the solution were sonicated in an ultrasonic bath flow. The oxidation process resulted in functionalization of the DWNTs and MWNTs with a carboxylic functional group (—COOH) on the CNT surfaces. The CNTs were cleaned using de-ionized water and filtered using a 2 μM mesh Teflon thin film filter under a vacuum. The CNTs collected from the Teflon thin film were dried under vacuum in preparation for epoxy nanocomposite fabrication. The COOH-functionalized DWNTs were further functionalized with a NH₂-group utilizing a wet chemical process (see, Z. Konya, I. Vesselenyi. K. Niesz, A. Kukovesz, A. Demortier, A. Fonseca, J. Delhalle, Z. Mekalif, J. B. Nagy, A. A. Koos, Z. Osvath, A. Kocsonya, L. P. Biro, I. Kiricsi, Chemical Physics Letters 360, 429 (2002)). FIG. 1 shows an SEM image of NH₂-functionalized DWNTs illustrating the relative high roughness of the DWNT's surfaces.

### Dispersion of CNTs by Microfluidic Process

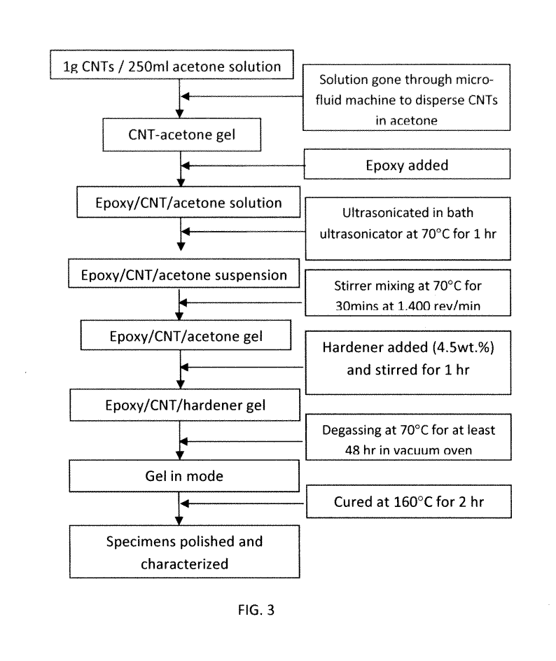

Referring to FIG. 3, a readily reproducible microfluidic process for achieving highly homogeneous dispersions of CNTs was utilized. The microfluidic machine may be purchased from Microfluidics Corp., Newton, Mass., (Microfluidizer® Model 110Y, serial 2005006E), which uses high-pressure streams that collide at ultra-high velocities in precisely defined micron-sized channels. Its combined forces of shear and impact act upon products to create uniform dispersions. CNT dispersions were prepared utilizing the microfluidizer processor to generate high shear forces in the dispersion to effectively break up CNT ropes and bundles. In step 301, CNTs were mixed with acetone and dispersed in step 302 using the microfluidic processor at an elevated pressure. After dispersion, well dispersed mixtures of CNTs in the acetone solvent manifest themselves as a gel (303). FIG. 2 shows a picture of NH₂-DWNT in acetone solution dispersed by the microfluidic process compared to a dispersion by an ultrasonic horn (a traditional method used to disperse CNTs) one hour after the dispersion process (0.5 g NH₂-DWNTs in 200 ml acetone in each glass beaker). The higher quality of the dispersions is observed.

### Sample Preparation for Mechanical Properties Evaluation

Epon 828 resin was then added in step 304 in the CNT/acetone gel at ratios needed for sample preparation (305). In step 306, the mixing process may use a stirrer at 70° C. for half an hour at a speed of 1000 rev/min to produce a suspension on 307 followed by an ultrasonication process in step 308 to evaporate the acetone and disperse the DWNTs in the epoxy matrix (309). The hardener (dicyandiamide) was then added in step 310 into the mixture at a ratio of 4.5 wt. % and mixed by stirring at 70° C. for 1 hour to produce an epoxy/CNT/hardener gel (311). The mixture was degassed in step 312 in a vacuum oven at 70° C. for 2-48 hours. In step 313, the mixture was then poured into a release agent-coated Teflon mold and cured at 160° C. for 2 hours in step 314. The specimens were polished in step 315 using fine sandpaper to create flat and smooth surfaces for ASTM evaluation.

In this study, neat, non-functionalized, COOH-functionalized DWNTs, COOH-functionalized MWNTs, and NH₂-functionalized DWNT reinforced epoxy nanocomposites were synthesized for comparison.

### Characterization

An MTS Servo Hydraulic test system (capacity 22 kips) was used for 3-point bending testing for flexural strength and modulus evaluation (based on ASTM D790). It was also used for compression strength testing (ASTM E9). Impact strength was tested based on ASTM D256. Vibration damping was tested based on ASTM E756.

A Hitachi S4800 FEI XL50 High Resolution SEM/STEM system was used for SEM imaging of the fracture surfaces of both reinforced epoxy nanocomposites.

### Results

Table 1 shows mechanical properties of the CNT-reinforced (both D T and MWNT) epoxy nanocomposites compared with an epoxy neat sample.

TABLE 1

| | Compression | Flexural | Flexural | Impact | |
|---|---|---|---|---|---|
| | strength | strength | modulus | strength | Vibration |
| Material | (MPa) | (MPa) | (GPa) | (J/m) | damping |
| Neat Epon 828 | 125 | 116 | 3.18 | 270 | 0.331 |
| DWNT (1.2 wt. %)/Epon 828 | | 120 | 3.56 | | |
| COOH-DWNT (1.2 wt. %)/Epon 828 | | 137 | 3.70 | | |
| NH₂-DWNT(1.2 wt. %)/Epon 828 | | 155 | 3.70 | | 0.466 |
| NH₂-DWNT(0.5 wt. %)/Epon 828 | | 139 | 3.26 | | |
| NH₂-DWNT(1.8 wt. %)/Epon 828 | 172 | 165 | 3.70 | 355 | 0.476 |
| COOH-MWNT (0.5 wt. %)/Epon 828 | 131 | 144 | 3.38 | | |
| COOH-MWNT (0.75 wt. %)/Epon 828 | 138 | 151 | 3.57 | | |
| COOH-MWNT (1.0 wt. %)/Epon 828 | 158 | 159 | 3.61 | | |
| COOH-MWNT (1.25 wt. %)/Epon 828 | 170 | 162 | 3.70 | | |
| COOH-MWNT (1.5 wt. %)/Epon 828 | 180 | 168 | 3.72 | | |
| MWNT (1.5 wt. %)/Epon 828 | 135 | 125 | 3.58 | | |

From the results in Table 1, one can conclude that proper functionalization of DWNTs has a great effect on the flexural strength of the epoxy nanocomposites. Compared with the neat epoxy, improvement of flexural strength was 3%, 18%, and 33%, respectively, for the non-functionalized, COOH-functionalized and NH₂-functionalized DWNT-reinforced epoxy nanocomposites at 1.2 wt. % loading. At NH₂-DWNT loading of 1.80 wt. %, compression strength, flexural strength, modulus, impact strength, and vibration damping factors were improved 39%, 42%, 16%, 31%, and 44%, respectively, compared with the neat epoxy. Further improvement may be seen by increasing the loading of the NH₂-DWNTs; however, the viscosity of the epoxy becomes higher with increasing loading of the DWNTs. The heightened viscosity makes higher loading of the CNTs impractical for epoxy nanocomposite fabrication.

The results in Table 1 show that the NH₂-DWNT reinforced epoxy nanocomposite is more effective for the improvement of the mechanical properties of the epoxy matrix than COOH-DWNT reinforced epoxy nanocomposites. NH₂-functional groups located on the surface of the DWNTs react and form covalent bonds with the epoxy matrix, and as a result, significantly enhance the interfacial adhesion. The NH₂-functional groups are terminated at the open end of the DWNTs. As a result, the DWNTs can be integrated easily into the epoxy matrix via a reaction with the epoxy, and consequently become an integral part of the matrix structure (see, J. Zhu, H. Peng, F. Rodriguez-Macias, J. L. Margrave, V. N. Khabashesku, A. M. Imam, K. Lozano, and E. V. Barrera, Advanced Functional Materials 14, 643 (2004)).

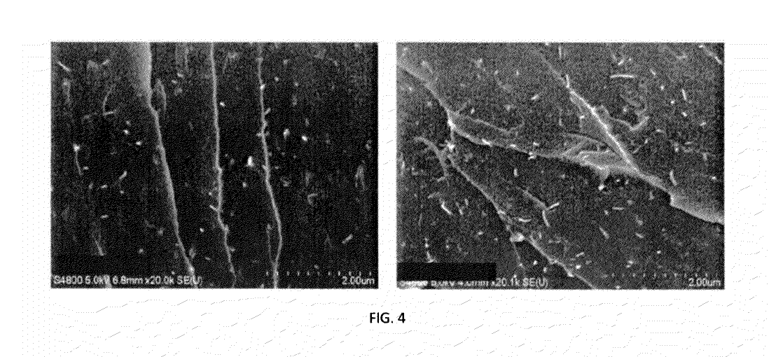

As for the COOH-CNT reinforced epoxy nanocomposites, the surface of the DWNTs affects the wettability between the surface of CNTs and the matrix. It is very possible that the COOH-CNTs are hydrophilic to the epoxy matrix after the functionalization, which improves their dispersion in the epoxy matrix (see, J. Zhu, H. Peng, F. Rodriguez-Macias, J. L. Margrave, V. N. Khabashesku, A. M. Imam, K. Lozano, and E. V. Barrera, Advanced Functional Materials 14, 643 (2004)). The COOH-functional groups attached onto the CNTs offer an opportunity for chemical interactions with the epoxy matrix and enhanced mechanical properties. FIG. 4 shows flexural surfaces of both COOH-MWNTs (1.5 wt. %) and non-functionalized MWNTs (1.5 wt. %) in an epoxy matrix. In both cases, the CNTs are very well dispersed in the epoxy matrix. However, in the case of the COOH-MWNT (1.5 wt. %) epoxy, fewer and shorter CNTs are observed than with the non-functionalized MWNT (1.5 wt. %) epoxy on the flexural surface. This further confirms that the bonding strength between the COOH-MWNTs and epoxy is much stronger than between the non-functionalized MWNTs and epoxy matrix. The carbon nanotubes are more likely broken than simply pulled out. This also indicates that using functionalized CNTs can effectively prevent the crack propagation and improve the bonding strength with the substrate.

What is claimed is:

1. A method comprising:
functionalizing carbon nanotubes (CNTs) with a functional group configured to form bonds with an epoxy matrix;
dispersing the functionalized CNTs in a solution with a microfluidic machine; and
mixing the solution of dispersed functionalized CNTs with the epoxy matrix.

2. The method as recited in claim 1, wherein the solution comprises acetone.

3. The method as recited in claim 1, wherein the CNTs comprise double-walled carbon nanotubes.

4. The method as recited in claim 1, wherein the CNTs comprise multi-walled carbon nanotubes.

5. The method as recited in claim 1, wherein the functional group comprises a carboxylic functional group.

6. The method as recited in claim 5, wherein the functional group comprises a NH₂-group.

7. The method as recited in claim 3, wherein the mixing step further comprises sonication of the solution and epoxy matrix.

8. The method as recited in claim 1, further comprising adding a hardner.

9. The method as recited in claim 5, wherein the functional group comprises a COOH-group.

10. A method for coating a marine vessel, comprising:
mixing an epoxy material reinforced with carbon nanotubes to produce the coating; and
applying the coating to an exterior surface of the marine vessel.

11. The method as recited in claim 10, wherein the mixing comprises dispersing the carbon nanotubes in the epoxy material with a microfluidic process.

12. The method as recited in claim 11, wherein the carbon nanotubes are functionalized with functional groups.

13. The method as recited in claim 12, wherein the carbon nanotubes comprise double-wall carbon nanotubes.

14. The method as recited in claim 12, wherein the carbon nanotubes comprise multi-walled carbon nanotubes

15. The method as recited in claim 12, wherein the carbon nanotubes are functionalized with COOH-functional groups.

16. The method as recited in claim 12, wherein the carbon nanotubes are functionalized with NH₂-functional groups.

17. A marine vessel coating comprising an epoxy material reinforced with carbon nanotubes.

18. The marine vessel coating as recited in claim 17, wherein the carbon nanotubes are functionalized with functional groups.

19. The marine vessel coating as recited in claim 17, wherein the carbon nanotubes are functionalized with COOH-functional groups.

20. The marine vessel coating as recited in claim 17, wherein the carbon nanotubes are functionalized with NH₂-functional groups.
